(19) United States
(12) Patent Application Publication
(10) Pub. No.: US 2014/0258306 A1
(43) Pub. Date: Sep. 11, 2014

(54) Novel Simulation and Permutation Methods for the Determination of Temporal Association between Two Events

(71) Applicant: THE JOHNS HOPKINS UNIVERSITY, Baltimore, MD (US)

(72) Inventors: Jeanne S. Nunez, Laurel, MD (US); Peter Murakami, Baltimore, MD (US); Daniel Glen, Baltimore, MD (US)

(73) Assignee: THE JOHNS HOPKINS UNIVERSITY, Baltimore, MD (US)

(21) Appl. No.: 14/351,170

(22) PCT Filed: Oct. 12, 2012
(86) PCT No.: PCT/US2012/059970

§ 371 Date: Apr. 11, 2014

Related U.S. Application Data
(60) Provisional application No. 61/546,293, filed on Oct. 12, 2011.

(51) Int. Cl. G06F 19/00

(52) U.S. Cl. CPC G06F 19/3431
USPC 707/741

(57) ABSTRACT

An embodiment in accordance with the present invention provides methods and software for determining an association between two health events, temporally. The methods can be implemented on a computing device either individually, or as a group, and are noted as simulation, permutation shuffling, and permutation sliding. Simulation, permutation shuffling, and permutation sliding each use the comparison of the experimentally found occurrence of association between the two health events to the null distribution of the association statistics, obtained by independently simulating the two health events. In particular, these methods of determining association between two health events can be used for determining an association between reflux and apnea in infants. However, these methods can also be applied more generally to determining a potential relationship between health or other events in the temporal plane.

### CROSS REFERENCE TO RELATED APPLICATIONS

This application claims the benefit of U.S. Provisional Patent Application No. 61/546,293, filed Oct. 12, 2011, which is incorporated by reference herein, in its entirety.

### GOVERNMENT SUPPORT

This invention was made with government support under UL1RR025005 awarded by the National Institute of Health. The government has certain rights in the invention.

### FIELD OF THE INVENTION

The present invention relates generally to the study of event association. More particularly, the present invention relates to a method for determining a temporal association between events.

### BACKGROUND OF THE INVENTION

Gastro-esophageal reflux (GERD) is often considered as a cause for a variety of non-specific symptoms, most commonly chest pain and heartburn. Association between reflux with other symptoms, such as cough and apnea, in infants has been more controversial despite the widespread use of anti-reflux medications and reflux surgery in these patients. GERD and its symptoms constitute a problem that affects an estimated 5-40% of the adult population. Therefore, establishing a temporal association between these symptoms and reflux may suggest a cause-effect relationship and guide medical and surgical management.

The typical statistical methods used to analyze temporal association between gastro-esophageal reflux and symptoms include the SI (Symptom Index), SSI (Symptom Sensitivity Index), and SAP (Symptom Association Probability). These methods are included in commercial products such as the Sandhill Scientific Mil software for analysis of reflux using multichannel intraluminal impedance (MU). Using these statistical methods, it has been shown that temporal association between polysomnographic obstructive apneas and reflux events in former premature infants at term, could be demonstrated at a single-subject level analysis and is consistent with both clinical history and outcome.

SI measures the percentage of symptoms associated with reflux events out of the total number of symptoms. SI is a measure of sensitivity and is usually considered significant if >50%. SSI measures the percentage of reflux events associated with symptoms out of the total number of reflux episodes, and may be interpreted as the positive predictive value of reflux for a symptom. SSI is arbitrarily considered significant if more than 10%. Rather than the commonly used fractional metrics SI and SSI, a statistical assessment of the significance of the association is required.

The Fisher exact test is used in the Sandhill SAP. In order to fit the framework of a contingency table, the length of the study is discretized into time bins that are then classified as positive or negative for reflux or symptom events. The Fisher exact test computes the probability of observing this number of pairs of positive reflux-symptom events under the null hypothesis that pairs of symptom-reflux events may occur by chance. Unfortunately, binning limits what can be considered an association between events.

In “algorithm 1” of the Sandhill SAP, a symptom is not counted as associated with a reflux event if both occur in the same time bin even if they both occur within the same association window. In “algorithm 2” of the Sandhill SAP, this issue is resolved but at the cost of violating the rule of independence of the Fisher exact test. If two symptoms occur within the same window of association with the same reflux event but in two successive bins, they are both counted as associated; however, the Fisher exact test is valid only for independent paired reflux-symptom events; neither multiple refluxes per symptoms nor multiple symptoms per reflux are allowed.

Another metric, the Ghillebert Probability Estimate (GPE), has also been used occasionally to analyze temporal association between reflux and symptoms and found to provide results comparable to the SAP. As opposed to the SAP, which uses a two-by-two contingency table, the GPE separates the study into at-risk and low-risk periods. The high risk period is defined as the sum of the total time pH is less than 4 and the total of the 2 minute intervals for each reflux event. Unfortunately, this method has been tested only with pH monitoring and not with MIT reflux. Furthermore, it has been shown that the GPE may overestimate the “at-risk period,” if reflux events are spaced less than 2 minutes apart.

It would therefore be advantageous to provide a method for determining a temporal association between two medical events that is accurate and easy to use.

### SUMMARY OF THE INVENTION

The foregoing needs are met, to a great extent, by the present invention, wherein in one aspect, a method for determining an association between two types of health events during a tested association window size in a patient, using a computer readable medium configured to execute steps including determining data related to a timing of and a number of occurrences of a first type of health event at d a second type of health event. The method also includes computing a value for a symptom index for the first type of health event and the second type of health event using the a fraction of the number of occurrences of events of the second type occurring within the tested association window size following an event of the first type compared to the total number of events of the second type. Additionally, the method includes computing a value for the symptom sensitivity index similarly by using a fraction of the number of occurrences of events of the first type occurring within the tested association window size preceding an event of the second type compared to the total number of events of the second type. The symptom index value, the symptom sensitivity index value, and the p-value of the symptom index and symptom sensitivity index obtained in simulation and permutation data can be used to determine whether there is an association between the first type of event and the second type of event. In addition the method includes determining a. care and treatment plan for the patient based on whether there is an association between the first type of event and the second type of event.

In accordance with an aspect of the present invention, the first type of event takes the form of a reflux event and the eLond type of event takes the form of one selected from a group of an apnea, cough, and pain events. The method can further include determining a number of association windows having a predetermined duration, and calculating the symptom index, the symptom sensitivity index, and the p-value for each one of the number of association windows. The simulation of constraints can be applied between events for both types of events, and the constraint can take the form of a minimum gap.

In accordance with another aspect of the present invention, a method for determining an association between two health events in a patient, using a computer readable medium configured to execute steps includes determining data related to a length of time between occurrences of a first type of health event and a second type of health event. The method includes computing a value for a symptom index for the first type of health event and the second type of health event using the length of time between occurrences of the first type of health event and the length of time between occurrences of the second type of health event. The method also includes computing a value for a symptom sensitive index for the first type of health event and the second type of health event using the length of time between occurrences of the first type of health event and the length of time between occurrences of the second type of health event. The symptom index value, the symptom sensitive index value, and the p-value obtained with permutation methods can be used to determine whether there is an association between the first type of event and the second type of event. Additionally, the method can include determining a care and treatment plan for the patient based on whether there is an association between the first type of event and the second type of event.

In accordance with another aspect of the present invention, the first type of event takes the form of a reflux event, and the second type of event takes the form of an apnea event. The method can also include re-ordering the lengths of time between occurrences of the first type of event and lengths of time between the occurrences of the second type of event a predetermined number of times. The symptom index, the symptom sensitive index, and the p-value for each of the predetermined number of times can also be calculated. Further, the method includes shifting the lengths of time between occurrences of the first type of event and lengths of time between occurrences of the second type of event by random amounts for a predetermined number of times and calculating the symptom index, the symptom sensitivity index, and the p-value for each of the predetermined number of times. Additionally, the method includes wrapping-around any length of time between occurrences of the first type of health event and any length of time for the second type of health event that extend beyond an end time.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 illustrates a flow diagram of a method of determining an association between two health events temporally, according to an embodiment of the present invention.

FIG. 2 illustrates a flow diagram of a method of determining an association between two health events temporally, according to another embodiment of the present invention.

FIGS. 3 and 4 illustrate the results of the temporal profile of p-values for all methods are compared for the four subjects with the symptom association probability, the present standard of care.

FIG. 5 illustrates the effect of the window association size on the SI and SSI values using the permutation sliding method.

FIG. 6 illustrates a graphical view of temporal association simulation and permutation methods.

### DETAILED DESCRIPTION

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

An embodiment in accordance with the present invention provides methods and software for determining an association between two health events, temporally. The methods can be implemented on a computing device either individually, or as a group, and are noted as simulation, permutation shuffling, and permutation sliding. Simulation, permutation shuffling, and permutation sliding each use the comparison of the experimentally found occurrence of association between the two health events to the null distribution of the association statistics, obtained by independently simulating the two health events. In particular, these methods of determining association between two health events can be used for determining an association between reflux and apnea in infants. However, these methods can also be applied more generally to determining a potential relationship between health events or other events, in the temporal plane.

As a part of the present invention, three novel methods have been developed and implemented as software for execution on a computing device. The three methods can be implemented on the computing device either individually, or as a group, and are noted as simulation, permutation shuffling, and permutation sliding. These three methods can be used independently or all together to test for and verify temporally an association between two health events, such as, for example, reflux and apnea. The methods are preferably embodied as a software program, which can be executed on a computing device, such as a desktop or laptop computer, tablet, smartphone, server, or other computing device known to or conceivable by one of skill in the art. The software program can be stored on any suitable computer readable medium known to or conceivable by one of skill in the art. Preferably, the software is written in R, a freely available statistical programming language and environment, but it should be noted that any suitable software platform known to or conceivable by one of skill in the art could also be used.

Simulation, permutation shuffling, and permutation sliding each use the comparison of the experimentally found occurrence of association between the two health events to the null distribution of the association statistics, obtained by independently simulating the two health events. A permutation method takes as input the number and timing of the two health events and a simulation method takes only the number of each of the two health events. For all three methods, SI and SSI were computed for each simulated iteration, and compared to the observed value.

Simulation, permutation shuffling, and permutation sliding methods can be used to estimate p-values at varying windows of association that generally followed the same pattern of the SAP. However, SAP has a more erratic pattern that is the result of binning. Simulation, permutation shuffling and, permutation sliding allow for use of a temporal profile, which provides a more robust set of measures and highlights the deficiencies in SAP. These new methods also allow for a supplementation of the measures of SI and SSI with p-values. Therefore, these new measures are referred to as SIP and SSIP (symptom index and symptom sensitivity index p-value), respectively. SIP and SSIP can be used as a clinical tool at the single subject level in order to analyze the temporal association between two health events as well as between two time series of events.

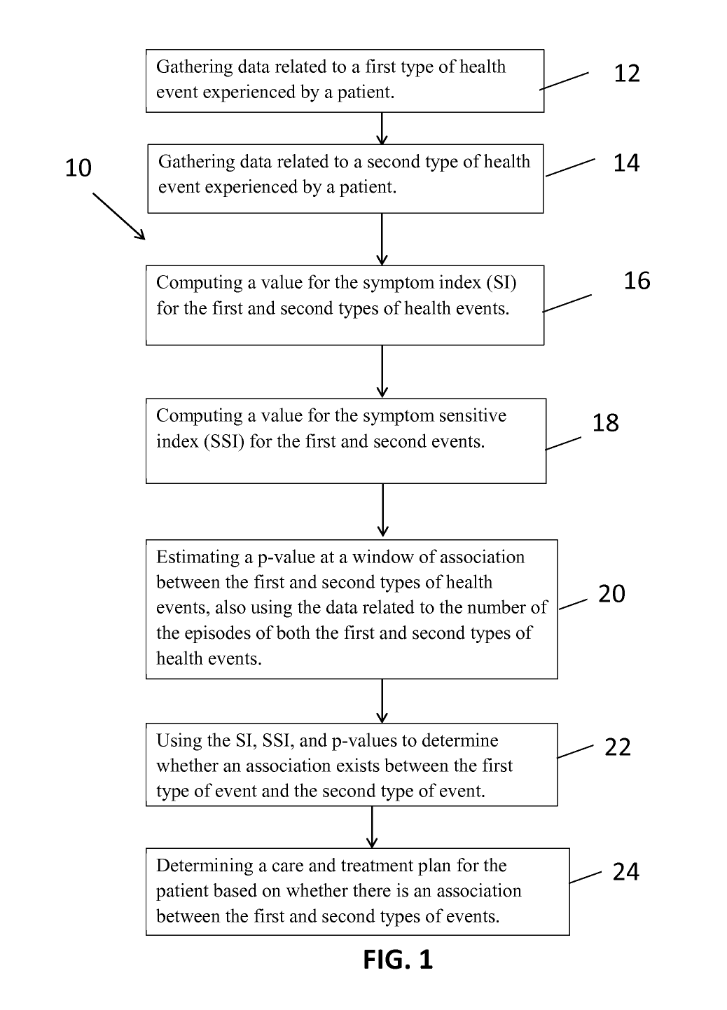

FIG. 1 illustrates a flow diagram of a simulation method in accordance with an embodiment of the present invention. In the method 10 a step 12 includes gathering data related to a first type of health event experienced by a patient. Step 14 includes gathering data related to a second type of health event experienced by a patient. In the example, described below the first type of health event takes the form of reflux and the second type of health event takes the form of apnea. While any type of health events can be studied with this method, the example of reflux and apnea is included to further illustrate the application of the method. Step 16 includes computing a value for the symptom index (SI) for the first and second types of health events and step 18 includes computing a value for the symptom sensitive index (SSI) for the first and second events. For the simulation method, both steps 16 and 18 include using the number of the episodes of the first type of health event and the number of the episodes of the second type of health event. Step 20 includes estimating a p-value at a window of association between the first and second types of health events, also using the data related to the number of the episodes of both the first and second types of health events. In step 22 the SI, SSI, and p-values are used to determine whether an association exists between the first type of event and the second type of event. Step 24 includes determining a care and treatment plan for the patient based on whether or not there is an association between the first and second types of events.

More particularly, with respect to the simulation method, illustrated in FIG. 1, if there are m episodes of the first type of event, n episodes of the second type of event, and h is the length of the study, a random sample of m events and a separate sample of n events are generated 10,000 times from a uniform distribution on time interval (0, h) for that subject. The SI, SSI, and p-values for 20 association windows are then calculated, generating a null distribution of association. In order to address restrictions imposed by observation methods and the possibility of temporal clustering of unobservable events, first and second types of events are required to have a minimum gap between events. For example, with respect to the reflux and apnea model discussed below, a gap of 30 seconds between reflux events was chosen, which merges multiple reflux episodes, if they occur within 30 seconds of each other. A gap between apnea events as estimated at 6 seconds based on an average respiratory rate of 40 breaths per minute with the minimal apnea time lasting at least 2 breaths+one breath before and after the apneic event.

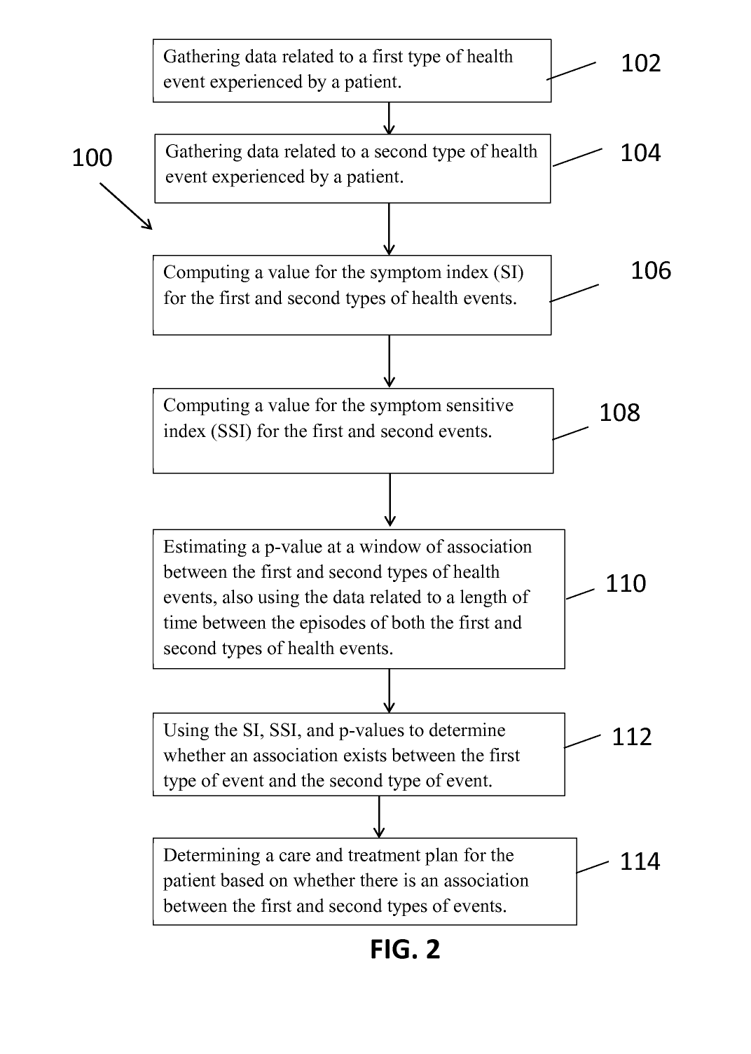

FIG. 2 illustrates a flow diagram of a permutation method in accordance with an embodiment of the present invention. In the method 100 a step 102 includes gathering data related to a first type of health event experienced by a patient. Step 104 includes gathering data related to a second type of health event experienced by a patient. In the example, described below the first type of health event takes the form of reflux and the second type of health event takes the form of apnea. While any type of health events can be studied with this method, the example of reflux and apnea is included to further illustrate the application of the method. Step 106 includes computing a value for the symptom index (SI) for the first and second types of health events, and step 10 includes computing a value for the symptom sensitive index (SSI) for the first and second events. For the simulation method, both steps 106 and 108 include using a duration of time between each occurrence of the first type of event and between each occurrence of the second type of event. Step 110 includes estimating a p-value at a window of association between the first and second types of health events, also using the duration of time between each occurrence of the first type of event and between each occurrence of the second type of event. In step 112 the SI, SSI, and p-values are used to determine whether an association exists between the first type of event and the second type of event. Step 114 includes determining a care and treatment plan for the patient based on whether or not there is an association between the first and second types of events.

With respect to the more particular permutation shuffling method, the time intervals between events are calculated (including start and end times), and randomly re-ordered, separately for, by way of example, apneas and refluxes. This is done 10,000 times, each time calculating the SI, SSI, and p-value observed in the resulting sample. For example, given a group of reflux events and a group of apneic events, a calculation to get the time difference between events of each type is computed (D1 . . . Dn). The time differences are permuted (D1, D2, D3, . . . )→(D2, D1, D3, . . . ). Then a new event time is computed by the cumulative sums of those time differences, e.g. (D2,D1,D3, . . . )→(D2, D2+D1, D2+D1+D3, . . . ). In this way, all time-wise structure has been nullified, while any subject-wise structure of event intervals has been maintained. Rather than assuming event times to be uniformly distributed, their distribution is estimated from the observed data.

The permutation sliding method, another type of more specific permutation method, independently shifts the subject's apnea and reflux times by random amounts, with wrap-around for the tunes that extend past the end time. This process is repeated 10,000 times, and each tune SI, SSI, and p-value are calculated, as with the simulation method and permutation shuffling method.

The null hypothesis of all the methods described in FIGS. 1 and 2, is the lack of any association between the first and second types of events beyond what is expected by chance alone. The null hypothesis for the permutation shuffling method is similar but assumes a set of events that shares the same temporal frequency as the original observed data. The null hypothesis for the permutation sliding method goes further by restricting the events to the same order as the original events. The null hypothesis for the permutation sliding method can then be summarized as: given two observed sets of events, a random association of events is seen by simply moving the temporal origin. Both the shuffling and sliding permutation methods assume that the time-wise structure in the data for a given subject is representative of the underlying reflux- and apnea-generating mechanism for that subject; whereas, the simulation method simply assumes that there is no underlying structure.

The simulation method carries assumptions like that of a discrete uniform distribution and constraints imposed by unobservable events. Those constraints require specific knowledge of how the original events are determined in polysomnography and impedance analysis software packages, e.g. 30 seconds between reflux events. Furthermore, a divergence of the p-values at longer duration of association for the simulation method was observed when compared to the two other methods of permutation. The divergence of the simulation method may be explained by the fact that the assumption of uniformly distributed event times is not true because of the tendency of events to cluster together in time. The shuffling and sliding permutation methods, on the other hand, do not assume a uniform distribution but rather estimate that distribution from the observed data. Both shuffling and sliding permutation methods remove the constraint of the need for requiring a gap between events and the need for a uniform distribution. The permutation shuffling method removes these constraints by using the temporal frequency as it was observed. The sliding method, gives a result that removes many of the disadvantages of the permutation shuffling method yet requires no further constraints as imposed in the simulation method. However, this method has a more specific null hypothesis than the simulation method in that the evaluation is based not on two series of random events but on the specific series of events acquired in the experiment. Despite their methodological differences, the temporal profile between the two permutation methods showed a similar pattern of p-values, suggesting that these methods are similar and correctly assess the temporal association. The simulation and permutation methods, give an overall similar pattern of p-values. However, the use of a temporal profile illustrates the limitations of the SAP by showing an erratic pattern relating to binning, and the limitation of the simulation method which assumes a uniform distribution not met in our patients. If both types of events were truly randomly distributed, one would expect the temporal profiles to show fairly flat profiles. Consequently, the minimum p-value and the timing of that minimum value in the temporal profile are useful measures.

### EXAMPLE

The following example is included merely as an illustration of the present method and is not intended to be considered limiting. This example is one of many possible applications of the methods described above. Any other suitable application of the above described methods known to or conceivable by one of skill in the art could also be created and used. In the present example, four infants were used to determine whether the methods described above can be used to show an association between two health events, namely, reflux and apnea. The infants recruited were born at 23 to 29 weeks gestation with persistent clinical cardio-respiratory events (CR events) at 39 to 48 weeks post-menstrual age (PMA). Clinical CR events, prompting inclusion in the study, were defined for any of the following conditions: a heart rate less than 80 min, oxygen saturations less than 90% or cardio-respiratory monitor-defined apnea >20 seconds.

A standard polysomnography was performed with a 6.4 Fr trans-nasal MU-pH probe (Comfortec MII-pH probe, ZIN-BS-51, Sandhill Scientific, Highland Ranch, Colo.). The polysomnography and Mil-pH probe analysis systems were synchronized by digitally marking each tracing at the beginning of the study. The impedance data was analyzed using the Sandhill analysis software and validated manually. All signals were acquired digitally (Alice 4; Respironics Philip Andover, Mass. or Somnologica/Embla, Broomfield, Colo.). Polysomnography CR events were scored according to the standards of the American Academy of Sleep Medicine.

Temporal association was analyzed between polysotnnographic discrete obstructive apneas and all reflux events, detected by MII. For this study, the SAP (Weusten) method was modified to include only the right-tailed test (only the positive association between reflux and apnea) expressed as a p-value.

This subset of patients was chosen, because they represent some interesting extremes. Three subjects showed some level of temporal association between reflux and apnea (subject 1, 2, and 3). Two of the infants were recommended for fundoplication reflux surgery based on clinical observation, (subjects 1 and 3); one infant continued to have symptomatic reflux at follow-up two years later (subject 2). Subject 4 was chosen to test the method on a “negative” subject. Subject 4 had numerous apneas and reflux events but no evidence of association with any method chosen.

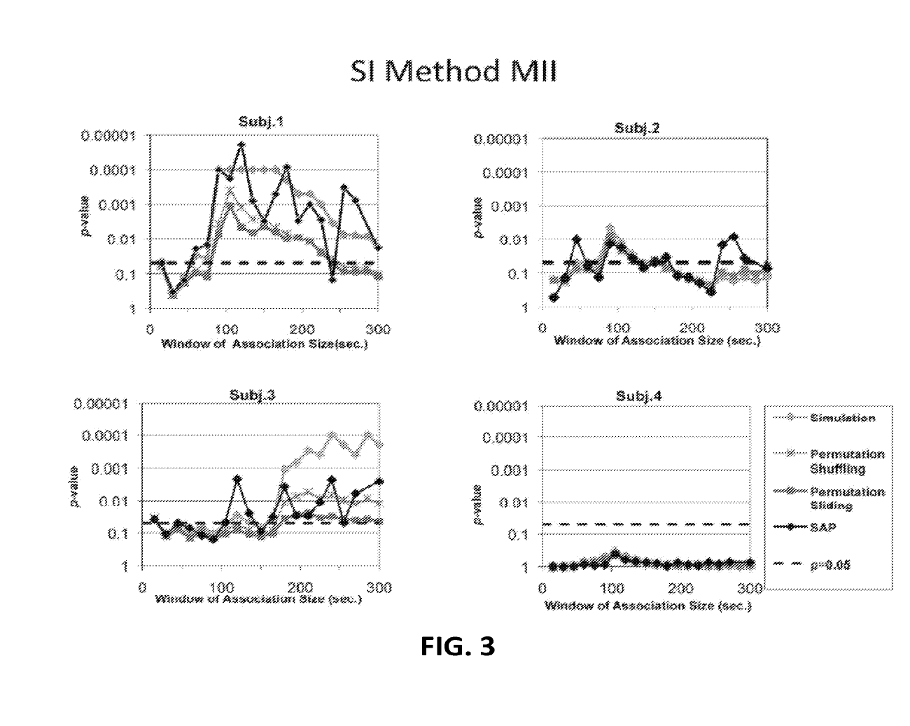

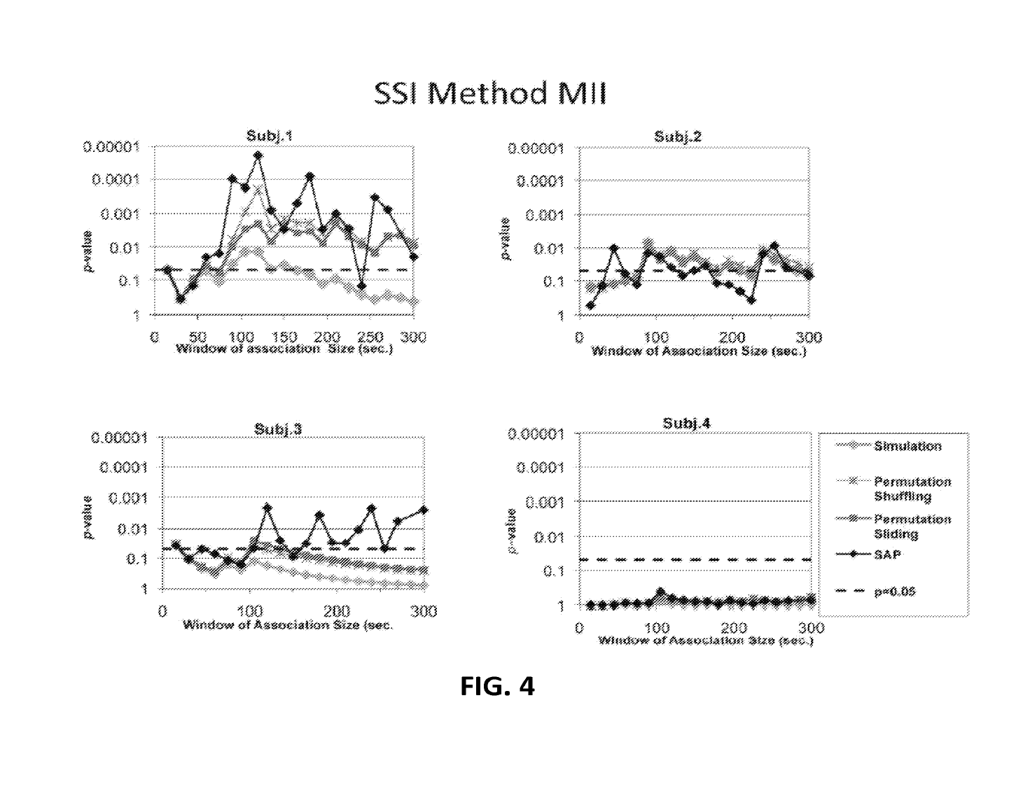

In FIGS. 3 and 4, the results of p-values for all methods are compared for the four subjects. For all subjects, all methods give overall similar results of p-values. However, for all subjects, the SAP has a more erratic pattern of p-values depending on the temporal association window size while the simulation, shuffling and sliding permutation methods all have smoother temporal profiles. In Subject 1 and 3, the distributions of the p-values for the Simulation method diverged from the other methods for both SIP and SSIP with longer association windows. For the fourth subject, the three methods confirmed the results of the SAP reporting weak SIP and SSIP estimates with non-significant p-values (FIGS. 3, 4, and 5).

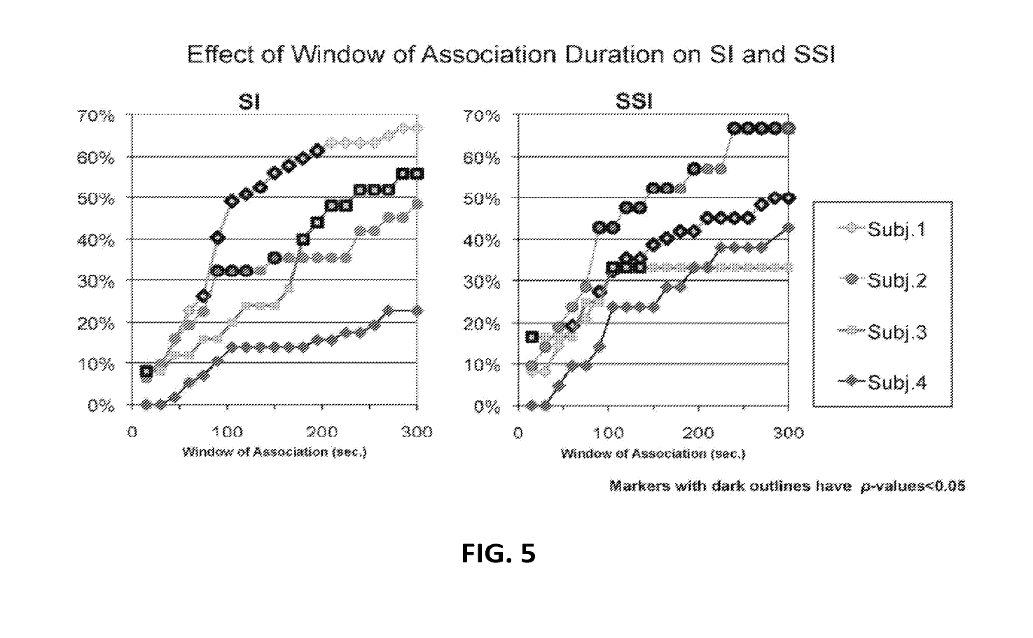

FIG. 5 shows the effect of the window association size on he SI and SSI values using the permutation sliding method. SIP reaches the 50% threshold at 105 sec, 300 sec and 240 sec for subjects 1, 2 and 3 respectively. SSIP reaches the 10% threshold at 45 sec, 30 sec, 15 sec and 90 sec for subject 1, 2, 3 and 4 respectively. FIG. 5 also shows that SIP and SSIP estimates even above the commonly used threshold values of 50% and 10% respectively may be associated with p-values at more than 0.05; and, conversely, SI and SSI estimates below threshold values may be associated with p-values at less than 0.05.

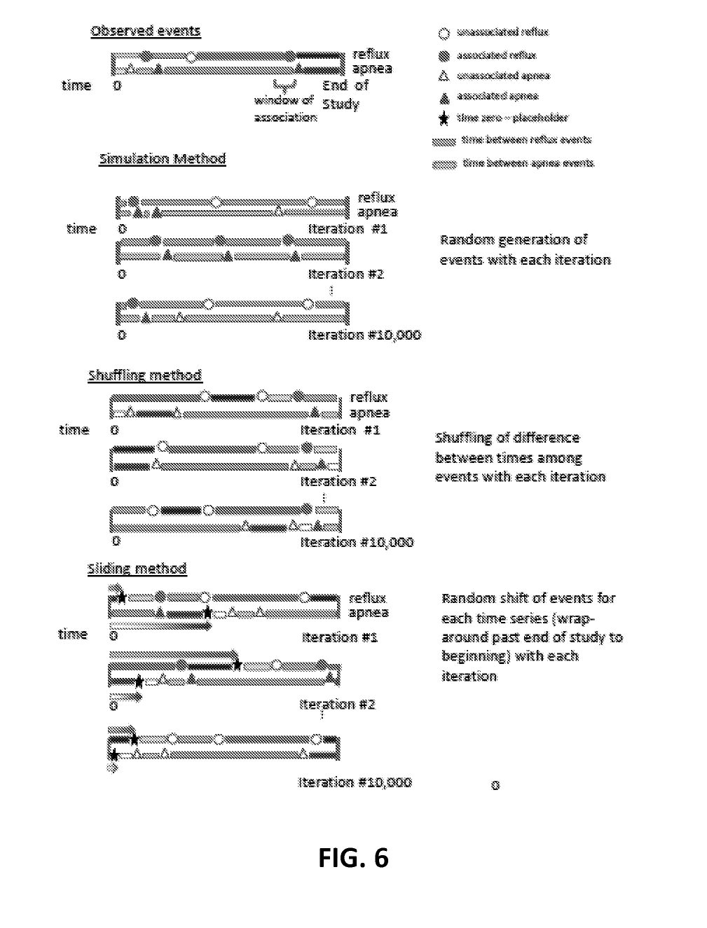

FIG. 6 illustrates a graphical view of temporal association simulation and permutation methods according to an embodiment of the present invention. For each iteration, the simulation method shows the random distribution of the same numbers of events and the recounting of the association between reflux and apnea events. The permutation shuffling method shows the shuffling of the time differences, the original horizontal bars between events. The permutation sliding method also uses the time difference, but maintains the same order as the original. The permutation sliding method also wraps around past the end of the study. The relative position of the temporal origin, time zero, is shown with an open circle. Time zero is shifted with the relative times of the original observed events.

TA was analyzed between polysomnographic obstructive apneas and Multi-channel Intraluminal Impedance (MII) reflux events. Three new numerical methods were compared to the SAP in four former premature infants with persistent apneas at term. The experimentally found association was compared to the association observed in simulated or permuted data consistent with no true association. Temporal association was computed based on symptom and symptom sensitivity indices, SIP and SSIP, with varying window of association (WA) times from 15 to 300s. The three new methods estimated p-values at varying WA that generally followed the same pattern of the SAP which had a more erratic pattern. The WA that gave the lowest p-value was approximately 120s.

These simulation and permutation methods have been used here for the specific problem of temporal association between apnea and reflux in premature infants at term. Because the methods themselves are independent of these requirements, we believe the same methods can be easily extended to other types of symptom (pain, cough, . . . ) and to other populations (infants and adults), but this will need to be tested in further studies. The day to day variability will also need to be tested. Even more generally, these methods developed here may be used for the temporal analysis between any two series of events.

The results presented here show both SIP and SSIP increase with the association window size, so a fixed cutoff such as 50% and 10% as a rule-of-thumb should be accompanied with the window size(s) on which they were evaluated and their associated p-value. Supplementing these measures of SI and SSI, we propose these new methods presented here as the measures of these p-values with the suggested nomenclature of SIP and SSIP (Symptom Index p-value and Symptom Sensitivity Index p-value, respectively).

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

1. A method for determining an association between two types of health events during a tested association window size in a patient, using a computer readable medium configured to execute steps comprising:
determining data related to a timing of and a number of occurrences of a first type of health event;
determining data related to a timing of and number of occurrence of a second type of health event;
computing a value for a symptom index for the first type of health event and the second type of health event using a fraction of the number of occurrences of events of the second type occurring within the tested association window size following an event of the first type compared to the total number of events of the second type;
computing a value for a symptom sensitivity index similarly by using a fraction of the number of occurrences of events of the first type occurring within the tested association window size preceding an event of the second type compared to the total number of events of the second type;
using the symptom index value, the symptom sensitivity index value, and a p-value of the symptom index and symptom sensitivity index obtained in simulation and permutation data to determine whether there is an association between the first type of event and the second type of event; and
determining a care and treatment plan for the patient based on whether there is an association between the first type of event and the second type of event.

2. The method of claim 1 wherein the first type of event comprises a reflux event.

3. The method of claim 1 wherein the second type of event comprises one selected from a group consisting of an apnea, cough, and pain events.

4. The method of claim 1 further comprising determining a number of association windows having a predetermined duration.

5. The method of claim 4 further comprising calculating the symptom index, the symptom sensitivity index, and the p-value for each one of the number of association windows.

6. The method of claim 1 further comprising applying the simulation of constraints between events for both types of events.

7. The method of claim 6 further comprising the constraint taking the form of a minimum gap.

8. A method for determining an association between two health events in a patient, using a computer readable medium configured to execute steps comprising:
determining data related to a length of time between occurrences of a first type of health event;
determining data related to a length of time between occurrences of a second type of health event;
computing a value for a symptom index for the first type of health event and the second type of health event using the length of time between occurrences of the first type of health event and the length of time between occurrences of the second type of health event;
computing a value for a symptom sensitive index for the first type of health event and the second type of health event using the length of time between occurrences of the first type of health event and the length of time between occurrences of the second type of health event;
using the symptom index value, the symptom sensitive index value, and a p-value obtained with permutation methods to determine whether there is an association between the first type of event and the second type of event; and
determining a care and treatment plan for the patient based on whether there is an association between the first type of event and the second type of event.

9. The method of claim 8 wherein the first type of event comprises a reflux event.

10. The method of claim 8 wherein the second type of event comprises an apnea event.

11. The method of claim 8 further comprising re-ordering the lengths of time between occurrences of the first type of event and lengths of time between the occurrences of the second type of event a predetermined number of times.

12. The method of claim 11 further comprising calculating the symptom index, the symptom sensitive index, and the p-value for each of the predetermined number of times.

13. The method of claim 8 further comprising shifting the lengths of time between occurrences of the first type of event and lengths of time between occurrences of the second type of event by random amounts for a predetermined number of times.

14. The method of claim 13 further comprising calculating the symptom index, the symptom sensitivity index, and the p-value for each of the predetermined number of times.

15. The method of claim 13 further comprising wrapping-around any length of time between occurrences of the first type of health event and any length of time for the second type of health event that extend beyond an end time.
